(19) United States
(12) Patent Application Publication
(10) Pub. No.: US 2014/0148336 A1
(43) Pub. Date: May 29, 2014

(54) METHODS OF CONTROLLING FUNGAL PATHOGENS USING POLYENE FUNGICIDES

(71) Applicants: Magalie GUILHABERT-GOYA, Davis, CA (US); Jonathan S. MARGOLIS, Davis, CA (US)

(72) Inventors: Magalie GUILHABERT-GOYA, Davis, CA (US); Jonathan S. MARGOLIS, Davis, CA (US)

(21) Appl. No.: 14/091,709

(22) Filed: Nov. 27, 2013

Related U.S. Application Data
(60) Provisional application No. 61/731,160, filed on Nov. 29, 2012.
(60) Provisional application No. 61/731,468, filed on Nov. 29, 2012.

(51) Int. Cl. A01N 43/22

(52) U.S. Cl. CPC A01N 43/22
USPC 504/100; 514/31

(57) ABSTRACT

The present invention relates to the control of fungal pathogens, such as pathogens that cause sudden death syndrome, in plants by applying one or more polyene fungicides to a plant seed, soil and/or plant roots.

### CROSS REFERENCE TO RELATED APPLICATIONS

This patent application claims priority to U.S. Provisional Patent Application No. 61/731,160, filed Nov. 29, 2012, and U.S. Provisional Patent Application No. 61/731,468, filed Nov. 29, 2012, the disclosures of both of which are hereby incorporated by reference.

### FIELD OF INVENTION

The present invention relates to the control of fungal pathogens, such as pathogens that cause sudden death syndrome, and the treatment and/or prevention of sudden death syndrome, in plants by applying one or more polyene fungicides.

### BACKGROUND OF INVENTION

Fungicides have many uses including crop protection and preservatives in food, feed, and cosmetics. Polyene fungicides are antifungal antibiotics that have been used in these fields. They may be obtained through fermentation of Streptomyces species, such as Streptomyces natalensis, which is commonly found in soil. Activity of polyene fungicides derives, in part, from their ability to damage cell membranes by forming complexes with ergosterol which is a building block of cell walls in fungi and yeast. Numerous studies have confirmed that the potential for development of fungi resistant to polyene fungicides is very low.

Exposure to fungal pathogens can cause a number of different diseases, including root rot. Specific diseases that cause root rot include sudden death syndrome, brown root rot, and fusarium wilt.

Sudden death syndrome (SDS) is a disease that affects soybeans, causing defoliation and pod abortion. The causal agents of SDS are soilborne fungi including U.S.: F. virguliforme (formerly classified as F. solani sp. glycines); South America: F. brasiliense, F. cuneirostrum, F. tucumaniae, and F. virguliforme. These Fusarium fungi survive the winter as chlamydospores in the crop residue or freely within the soil. The chlamydospores develop in the soil and on plant roots and can withstand wide soil temperature fluctuations and resist desiccation. When soil temperatures rise, chlamydospores are stimulated to germinate and then infect the roots of any nearby plants.

SDS was first identified in Arkansas in 1971, and has spread throughout the years. SDS has been reported to affect crops throughout most of the north central United States, including Illinois, Indiana, Iowa, Kansas, Kentucky, Minnesota, Mississippi, Missouri, Nebraska, Ohio, and Tennessee. SDS also affects crops in Canada, Argentina, and Brazil.

SDS has been very problematic to the farming industry. The causal fungi can survive for periods of time on nearby crops before becoming identifiable as having infiltrated the soybean crop. As the initial root symptoms are a discoloring of the tap root and lower stem, the initial onset of the disease is not readily observable in plants that are still growing. However, the disease will eventually cause yellow spotting on the upper leaves, which may eventually lead to a molting/mosaic appearance. Once the foliar symptoms (e.g., leaf spots) are visible, the crop is has already been exposed to the fungus for an extended period of time, and is likely already experiencing root rot.

Current SDS treatments are limited. Numerous treatment methods have been posited, including early planting, tillage, crop rotation, and resistant soybean varieties. See Andreas Westphal et al., “Sudden Death Syndrome”, Purdue Extension Publication BP-58-W (Aug. 26, 2010), available at http://www3.ag.purdue.edu/counties/montgomery/Documents/BP-58-W.pdf. As an alternative to the use of fungicides, chemical treatments have been attempted. For example, WO 2012/071520 describes the application of pyridinyl ethylbenzamide derivatives to reduce the occurrence of sudden death syndrome.

In particular, fungicides have been used with very limited effects. See, e.g., Dissertation of Japheth Drew Weems, “Effect of Fungicide Seed Treatments on Fusarium virguliforme and Development of Sudden Death Syndrome in Soybean,” University of Illinois at Urbana-Champaign, 2011. In the Weems study, soybean plants in various environments (laboratory, greenhouse, and field) were treated with fungicides that had previously shown some effectiveness against Fusarium. While several seed treatments decreased the lesion length and disease severity in the laboratory assays, the study showed no significant seed treatment effect for SDS severity for the field or greenhouse trials. The author concluded that “none of [the] seed treatments evaluated proved to have consistent effects on Fusarium virguliforme or SDS.”

In sum, SDS has negatively affected the farming industry for over 30 years. Treatment methods have had limited success. In particular, fungicides have been found to be ineffective thus far. See, e.g., Dan Hershman, “Kentucky: Soybean Sudden Death Syndrome Showing Up”, CropLife (Aug. 27, 2013), http://www.croplife.com/crop-inputs/fungicides/kentucky-soybean-sudden-death-syndrome-showing-up/ (“For sure, applying a fungicide WILL NOT HELP”).

### SUMMARY OF EMBODIMENTS OF THE INVENTION

The present invention relates to the control of fungal pathogens, such as pathogens that cause sudden death syndrome (SDS), by applying an effective amount of a polyene fungicide. The fungal pathogens may be soilborne fungi such as Fusarium virguliforme, Fusarium tucumaniae, F. brasiliense, and F. cuneirostrum. In one embodiment, the soilborne fungi is F. virguliforme or F. tucumaniae. In another embodiment, the soilborne fungi is F. virguliforme.

The fungicide may be applied to a plant, seed, soil in which a plant is growing, soil in which a plant or seed is about to be planted, plant roots, or combinations thereof. In a particular embodiment, the plant or seed is soybean.

In another embodiment, the invention provides for a soybean seed coated with a polyene fungicide.

In any of these embodiments, the polyene fungicide may be natamycin, nystatin, amphotericin B, aureofungin, filipin, lucensomycin, or combinations thereof. In a particular embodiment, the polyene fungicide is natamcyin. The polyene fungicide may be applied at a concentration of about 5 ppm to about 50 ppm or at a concentration of about 25 ppm to about 50 ppm.

In any of the above embodiments, the polyene fungicide may be included in a composition having an agriculturally acceptable carrier.

In any of these embodiments, the composition does not comprise pyridinyl ethylbenzamide derivatives.

### BRIEF DESCRIPTION OF THE DRAWINGS

FIG. 1 shows the results of the first experiment of Example 3, comparing root rot ratings for un-infested control (UIC) plants, infested control (IC) plants, and soybean roots treated with five different concentrations of natamycin.

FIG. 2 shows root vigor ratings for the first experiment of Example 3.

FIG. 3 shows the results of the second experiment of Example 3, comparing root rot ratings for UIC plants, IC plants, and soybean roots treated with five different concentrations of natamycin.

FIG. 4 shows root vigor ratings for the second experiment of Example 3.

### DETAILED DESCRIPTION OF EMBODIMENTS OF THE INVENTION

All publications, patents and patent applications, including any drawings and appendices, herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

The invention relates to the control of fungal pathogens and the treatment and/or prevention of diseases caused by these fungal pathogens, for example, sudden death syndrome, by applying an effective amount of a polyene fungicide. Root rot is an example of a type of disease that occurs from exposure to fungal pathogens. Specific diseases that cause the symptoms of root rot include sudden death syndrome, brown root rot, and fusarium wilt. The polyene fungicide may be applied to a locus in need of treatment in an amount effective to control a pathogen. In particular, the polyene fungicide may be applied to a plant seed, soil (e.g., soil prepared for planting), plant roots, or combinations thereof. The inventors have surprisingly found that the administration of polyene fungicides (e.g., natamycin) are effective in controlling such fungal pathogens and, specifically, in treating and/or preventing sudden death syndrome.

### Definitions

The term “controlling” means to kill or inhibit the growth of a fungal pathogen such as a fungus that causes sudden death syndrome.

The phrase “effective amount” refers to an amount of polyene fungicide sufficient to control a fungal pathogen or reduce the occurrence of sudden death syndrome. Such an amount can vary within a range depending on the fungus to be controlled, the type of plant, the climatic and environmental (i.e., soil type) conditions, the application method, and the type of polyene fungicide.

### Polyene Fungicides

Polyene fungicides are antifungal antibiotics with a macrocyclic lactone ring having (i) a rigid lipophilic polyene portion and a flexible, hydrophilic hydroxylated portion and (ii) the ability to bind to a sterol in the cell membrane of most fungi, principally ergosterol. The macrocyclic lactone ring may have 12-40 carbons, 6-14 hydroxyl groups and may or may not be linked to a carbohydrate. The ring may be linked to one or more sugars such as a simple sugar with five or more carbon units, a deoxy sugar, amino sugars and the like, which contain substituent groups attached to the ring including oxygenated linkages.

Polyene fungicides of the present invention may be obtained from a species of Streptomyces bacteria. Such fungicides include natamycin, nystatin, amphotericin B, aureofungin, filipin and lucensomycin as well as derivatives thereof. Examples of derivatives include the amphotericin B derivatives described in U.S. Pat. No. 5,606,038, for example, or the nystatin derivatives/analogues such as S44HP, NYST1068, and the octane nystatin described in Bruheim et al., Antimicrobial Agents and Chemotherapy, November 2004, pp. 4120-4129. Derivatives are naturally occurring analogs of a parent molecule or synthetic or semi-synthetic compounds derivatized from a parent molecule that retain at least some fungicidal activity compared to the parent molecule. In some embodiments, the derivatives have at least the same or greater fungicidal activity compared to the parent molecule. Derivatives include salts and solvates and other modified forms that have enhanced solubility compared to the parent molecule.

The polyene fungicide may be applied in concentration of at least 1 ppm, at least 5 ppm, at least 10 ppm, at least 15 ppm, at least 20 ppm, more preferably at least 25 ppm, more preferably at least 30 ppm, more preferably at least 35 ppm, more preferably at least 40 ppm, more preferably at least 45 ppm, more preferably at least 50 ppm, at least 55 ppm, at least 60 ppm, at least 65 ppm, at least 70 ppm, at least 75 ppm, at least 80 ppm, at least 85 ppm, at least 90 ppm, or at least 95 ppm, or at least 5, at least 10, at least 12.5, at least 15, at least 20, more preferably at least 25, more preferably at least 30, more preferably at least 35, more preferably at least 40, more preferably at least 45, more preferably at least 50, at least 55, at least 60, at least 65, at least 70, at least 75, at least 80, at least 85, at least 90, or at least 95 Ib/A for broadcast applications or 1, 2, 3, 4, 5, 6, 7, 8, 9, 10, 11, 12, 13, 14, 15, 16, 17, 18, 19, Ib/A for banded applications or 0.93, 1.86, 2.32, 2.79, 3.72, 4.65, 5.58, 6.51, 7.44, 8.37, 9.3, 10.23, 11.16, 12.09, 13.02, 13.95, 14.88, 15.81, 16.74, 17.67 mg per container or per plant roots. It will be understood that the polyene fungicide (e.g., natamycin) may be applied within particular ranges of these concentrations (e.g., 20-70 ppm, 25-50 ppm, etc.)

As described herein, the polyene fungicide may be included in composition with other additives. The polyene fungicide may comprise at least 1%, at least 2%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 96%, at least 97%, at least 98% or at least 99% of the composition.

### Fungal Pathogens/Treatment of SDS

The invention provides for methods of controlling phytopathogenic fungi by applying an effective amount of a polyene fungicide. Fungi that may be treated include Fusarium virguliforme, Fusarium tucumaniae, Fusarium brasiliense, and/or Fusarium cuneirostrum.

These fungi cause diseases such as SDS. The invention provides for methods of treating a plant, including plant roots, seed or soil to reduce the occurrence of SDS, and/or ameliorating SDS by applying an effective amount of a polyene fungicide (e.g., natamycin). The effectiveness of the polyene fungicide may be evaluated by analyzing root rot and/or plant vigor.

As shown in the Examples below, natamycin treatment had a significantly lower root rot rating and a significantly higher plant vigor rating compared to an infested control. A reduction of root rot in the treated composition in comparison to the untreated, infested control sample demonstrated that the treated composition have effectively prevented all or a substantial portion of the fungus from entering the root of the soybean plant. A higher root vigor in the treated composition as compared to the untreated, infested control demonstrated that the natamycin treatment allowed the seed to grow more vigorously in soil infested with the fungi than the untreated seeds were capable of growing.

The root rot is measured on a scale of 1-5, with a rating of 1=0% infection on taproot and lateral roots, a 2=<25% infection, a 3=25-50% infection, a 4=51-90% infection, and a 5=>90% infection. Root vigor was rated such that a rating of 4=healthy taproot and many lateral roots, a 3=fewer lateral roots and some stunting, a 2=fewer or stringy lateral roots and more stunting, 1=thin tap root and only a few lateral roots, and a 0=thin and stunted taproot with 0-3 lateral roots.

In one embodiment, the root rot is reduced by at least 5%, more preferably 10%, more preferably 15%, more preferably 20%, more preferably 25%, more preferably 30%, more preferably 35%, more preferably 40%, more preferably 45%, more preferably 50%, more preferably 55%, more preferably 60%, more preferably 65%, more preferably 70%, more preferably 75%, more preferably 80%, more preferably 85%, more preferably 90%, more preferably 95% as compared to the untreated, infested control.

In another embodiment, root vigor is increased by at least 5%, more preferably 10%, more preferably 15%, more preferably 20%, more preferably 25%, more preferably 30%, more preferably 35%, more preferably 40%, more preferably 45%, more preferably 50%, more preferably 55%, more preferably 60%, more preferably 65%, more preferably 70%, more preferably 75%, more preferably 80%, more preferably 85%, more preferably 90%, more preferably 95% as compared to the untreated, infested control.

### Plant and Seed Types

The methods described herein can be used to treat a variety of plants and seeds. These plants and seeds include, but are not limited to, soybeans, strawberry, tomato, artichoke, bulb vegetables, canola, cereal grains, citrus, cotton, cucurbits, edible beans, fruiting vegetables, herbs and spices, hops, leafy vegetables, legume vegetables, peanut, berries, root and tuber vegetables, sunflower, tree nuts, and maize. In a preferred embodiment, the method is used to treat sudden death syndrome in soybeans.

### Formulations

The polyene fungicides may be applied to a locus in need of treatment in an amount effective to control a pathogen. In one embodiment, the polyene fungicide can be applied to a plant seed, to soil in which a plant is growing, to soil in which a plant or seed is about to be planted, to a plant, especially plant roots, or combinations thereof. In a particular embodiment, the polyene fungicide is applied to a soybeen seed, a soybean root, or to soil in which soybean is growing or in which it is about to be planted, or combinations thereof.

In a further embodiment, the polyene fungicide is applied in the form of a suitable formulation. Such formulations may be prepared by mixing the polyene fungicide with agriculturally acceptable carriers and/or additives, for example extenders, solvents, diluents, dyes, wetters, dispersants, emulsifiers, antifoaming agents, preservatives, secondary thickeners, adhesives, and/or water. Formulations of the present invention may include agriculturally acceptable carriers, which are inert formulation ingredients added to formulations to improve recovery, efficacy, or physical properties and/or to aid in packaging and administration. Carriers may include anti-caking agents, anti-oxidation agents, bulking agents, and/or protectants. Examples of useful carriers include polysaccharides (starches, maltodextrins, methylcelluloses, proteins, such as whey protein, peptides, gums), sugars (lactose, trehalose, sucrose), lipids (lecithin, vegetable oils, mineral oils), salts (sodium chloride, calcium carbonate, sodium citrate), silicates (clays, amorphous silica, fumed/precipitated silicas, silicate salts), waxes, oils, alcohol and surfactants.

The application of a polyene fungicide to soil may be performed by drenching the polyene fungicide onto the soil, incorporating it into the soil, and in irrigation systems as droplet application onto the soil. The polyene fungicides may also be applied directly to plant roots or seeds (e.g., via immersion, dusting, or spraying). To assist in the application, the polyene fungicide can be also converted to formulations including, but not limited to, solutions, emulsions, wettable powders, suspensions, powders, dusts, pastes, soluble powders, granules, and suspension-emulsion concentrates.

For the purposes of the present invention, the composition of the invention is applied alone or in a suitable formulation to the seed. The seed is preferably treated in a condition in which its stability is such that no damage occurs in the course of the treatment. Generally speaking, the seed may be treated at any point in time between harvesting and sowing. Typically, seed is used which has been separated from the plant and has had cobs, hulls, stems, husks, hair or pulp removed. Thus, for example, seed may be used that has been harvested, cleaned and dried to a moisture content of less than 15% by weight. Alternatively, seed can also be used that after drying has been treated with water, for example, and then dried again.

When treating seed it is necessary, generally speaking, to ensure that the amount of the composition of the invention, and/or of other additives, that is applied to the seed is selected such that the germination of the seed is not adversely affected, and/or that the plant which emerges from the seed is not damaged. This is the case in particular with active ingredients which may exhibit phytotoxic effects at certain application rates.

The compositions of the invention can be applied directly, in other words without comprising further components and without having been diluted. As a general rule, it is preferable to apply the compositions in the form of a suitable formulation to the seed. Suitable formulations and methods for seed treatment are known to the skilled person and are described in, for example, the following documents: U.S. Pat. Nos. 4,272,417; 4,245,432; 4,808,430; 5,876,739; U.S. Patent Publication No. 2003/0176428, WO 2002/080675, WO 2002/028186.

The combinations which can be used in accordance with the invention may be converted into the customary seed-dressing formulations, such as solutions, emulsions, suspensions, powders, foams, slurries or other coating compositions for seed, and also ULV formulations.

These formulations are prepared in a known manner, by mixing composition with customary adjuvants, such as, for example, customary extenders and also solvents or diluents, colorants, wetters, dispersants, emulsifiers, antifoams, preservatives, secondary thickeners, stickers, gibberellins, and also water.

Colorants which may be present in the seed-dressing formulations which can be used in accordance with the invention include all colorants which are customary for such purposes. In this context it is possible to use not only pigments, which are of low solubility in water, but also water-soluble dyes. Examples include the colorants known under the designations Rhodamin B, C.I. Pigment Red 112 and C.I. Solvent Red 1.

Wetters which may be present in the seed-dressing formulations which can be used in accordance with the invention include all of the substances which promote wetting and which are customary in the formulation of active agrochemical ingredients. Use may be made preferably of alkylnaphthalenesulphonates, such as diisopropyl- or diisobutyl-naphthalenesulphonates.

Dispersants and/or emulsifiers which may be present in the seed-dressing formulations which can be used in accordance with the invention include all of the nonionic, anionic and cationic dispersants that are customary in the formulation of active agrochemical ingredients. Use may be made preferably of nonionic or anionic dispersants or of mixtures of nonionic or anionic dispersants. Suitable nonionic dispersants are, in particular, ethylene oxide-propylene oxide block polymers, alkylphenol polyglycol ethers and also tristryrylphenol polyglycol ethers, and the phosphated or sulphated derivatives of these. Suitable anionic dispersants are, in particular, lignosulphonates, salts of polyacrylic acid, and arylsulphonate-formaldehyde condensates.

Antifoams which may be present in the seed-dressing formulations which can be used in accordance with the invention include all of the foam inhibitors that are customary in the formulation of active agrochemical ingredients. Use may be made preferably of silicone antifoams and magnesium stearate.

Preservatives which may be present in the seed-dressing formulations which can be used in accordance with the invention include all of the substances which can be employed for such purposes in agrochemical compositions. Examples include dichlorophen and benzyl alcohol hemiformal.

Secondary thickeners which may be present in the seed-dressing formulations which can be used in accordance with the invention include all substances which can be used for such purposes in agrochemical compositions. Those contemplated with preference include cellulose derivatives, acrylic acid derivatives, xanthan, modified clays and highly disperse silica.

Stickers which may be present in the seed-dressing formulations which can be used in accordance with the invention include all customary binders which can be used in seed-dressing products. Preferred mention may be made of polyvinylpyrrolidone, polyvinyl acetate, polyvinyl alcohol and tylose.

The seed-dressing formulations which can be used in accordance with the invention may be used, either directly or after prior dilution with water, to treat seed of any of a wide variety of types. Accordingly, the concentrates or the preparations obtainable from them by dilution with water may be employed to dress the seeds of cereals, such as wheat, barley, rye, oats and triticale, and also the seeds of soybean, maize, rice, oilseed rape, peas, beans, cotton, sunflowers and beets, or else the seed of any of a very wide variety of vegetables. The seed-dressing formulations which can be used in accordance with the invention, or their diluted preparations, may also be used to dress seed of transgenic plants. In that case, additional synergistic effects may occur in interaction with the substances formed through expression.

For the treatment of seed with the seed-dressing formulations which can be used in accordance with the invention, or with the preparations produced from them by addition of water, suitable mixing equipment includes all such equipment which can typically be employed for seed dressing. More particularly, the procedure when carrying out seed dressing is to place the seed in a mixer, to add the particular desired amount of seed-dressing formulations, either as such or following dilution with water beforehand, and to carry out mixing until the distribution of the formulation on the seed is uniform. This may be followed by a drying operation.

The application rate of the seed-dressing formulations which can be used in accordance with the invention may be varied within a relatively wide range. It is guided by the particular amount of the at least one biological control agent and the at least one fungicide (I) in the formulations, and by the seed. The application rates in the case of the composition are situated generally at between 0.001 and 50 g per kilogram of seed, preferably between 0.01 and 15 g per kilogram of seed.

In some embodiments, the compositions are mixed with or further comprise at least one fertilizer, nutrient, mineral, auxin, growth stimulant, plant health enhancing microbe and the like, referred to below as plant health compositions. In some embodiments, the polyene fungicides of the present invention and plant health compositions are applied in combination or sequentially (where first one composition is applied and then another is applied later) to soybean seeds, to soybean plants, such as roots (e.g., through a root dip or soil drench) and/or to the plant's locus of growth (e.g., soil), either before, after and/or at the time of planting in a synergistically effective amount. A “synergistically effective amount” according to the present invention represents a quantity of a combination of a polyene fungicide and a plant health composition that is more effective at increasing root vigor and/or decreasing root rot than the sum of the effects of the polyene fungicide and plant health composition applied alone. Various equations, such as Gowing's equation, allow one to determine whether the effect of two components is synergistic. Gowing's Equation: Eₓₚ=X+[Y*(100−X)]/100. If E_{ob}>>Eₓₚ, then synergy exists.

A plant health composition/compound is a composition/compound comprising one or more natural or synthetic chemical substances, or biological organisms, capable of maintaining and/or promoting plant health. Such a composition/compound can improve plant health, vigor, productivity, quality of flowers and fruits, and/or stimulate, maintain, or enhance plant resistance to biotic and/or abiotic stressors/pressures.

Traditional plant health compositions and/or compounds include, but are not limited to, plant growth regulators (aka plant growth stimulators, plant growth regulating compositions, plant growth regulating agents, plant growth regulants) and plant activating agents (aka plant activators, plant potentiators, pest-combating agents). The plant health composition in the present invention can be either natural or synthetic.

Plant growth regulators include, but are not limited to, fertilizers, herbicides, plant hormones, bacterial inoculants and derivatives thereof.

Fertilizer is a composition that typically provides, in varying proportions, the three major plant nutrients: nitrogen, phosphorus, potassium known shorthand as N—P—K); or the secondary plant nutrients (calcium, sulfur, magnesium), or trace elements (or micronutrients) with a role in plant or animal nutrition: boron, chlorine, manganese, iron, zinc, copper, molybdenum and (in some countries) selenium. Fertilizers can be either organic or non-organic. Naturally occurring organic fertilizers include, but are not limited to, manure, worm castings, peat moss, seaweed, sewage and guano. Cover crops are also grown to enrich soil as a green manure through nitrogen fixation from the atmosphere by bacterial nodules on roots; as well as phosphorus (through nutrient mobilization) content of soils. Processed organic fertilizers from natural sources include compost (from green waste), bloodmeal and bone meal (from organic meat production facilities), and seaweed extracts (alginates and others). Fertilizers also can be divided into macronutrients and micronutrients based on their concentrations in plant dry matter. The macronutrients are consumed in larger quantities and normally present as a whole number or tenths of percentages in plant tissues (on a dry matter weight basis), including the three primary ingredients of nitrogen (N), phosphorus (P), and potassium (K), (known as N—P—K fertilizers or compound fertilizers when elements are mixed intentionally). There are many micronutrients, required in concentrations ranging from 5 to 100 parts per million (ppm) by mass. Plant micronutrients include iron (Fe), manganese (Mn), boron (B), copper (Cu), molybdenum (Mo), nickel (Ni), chlorine (Cl), and zinc (Zn).

Plant hormones a (aka phytohormones) and derivatives thereof include, but are not limited to, abscisic acid, auxins, cytokinins, gibberellins, brassinolides, salicylic acid, jasmonates, plant peptide hormones, polyamines, nitric oxide and strigolactones.

Plant activating agents are natural or synthetic substances that can stimulate, maintain, or enhance plant resistance to biotic and/or abiotic stressors/pressures, which include, but are not limited to, acibenzolar, probenazole, isotianil, salicyclic acid, azelaic acid, hymexazol, brassinolide, forchlorfenuron, benzothiadiazole (e.g., ACTIGARD® 50WG), microbes or elicitors derived from microbes. Microbes, or chemical compounds and peptides/proteins (e.g., elicitors) derived from microbes, can also be used as plant activating agents. Non-limiting exemplary elicitors are: branched-β-glucans, chitin oligomers, pectolytic enzymes, elicitor activity independent from enzyme activity (e.g., endoxylanase, elicitins, PaNie), avr gene products (e.g., AVR4, AVR9), viral proteins (e.g., vial coat protein, Harpins), flagellin, protein or peptide toxin (e.g., victorin), glycoproteins, glycopeptide fragments of invertase, syringolids, Nod factors (lipochitooligo-saccharides), FACs (fatty acid amino acid conjugates), ergosterol, bacterial toxins (e.g., coronatine), and sphinganine analogue mycotoxins (e.g., fumonisin B1). More elicitors are described in Howe et al., Plant Immunity to Insect Herbivores, Annual Review of Plant Biology, 2008, vol. 59, pp. 41-66; Stergiopoulos, Fungal Effector Proteins Annual Review of Phytopathology, 2009, vol. 47, pp. 233-263; and Bent et al., Elicitors, Effectors, and R Genes: The New Paragigm and a Lifetime Supply of Questions, Annual Review of Plant Biology, 2007, vol. 45, pp. 399-436.

Plant health promoting microbes include Bacillus spp. strains, such as Bacillus subtilis, Bacillus amyloliqeufaciens and Bacillus pumilus. Specific examples include Bacillus subtilis QST713. Bacillus subtilis QST713, its mutants, its supernatants, and its lipopeptide metabolites, and methods for their use to control plant pathogens and insects are fully described in U.S. Pat. Nos. 6,060,051; 6,103,228; 6,291,426; 6,417,163; and 6,638,910. In these U.S. Patents, the strain is referred to as AQ713, which is synonymous with QST713. Bacillus subtilis strain QST713 has been deposited with the NRRL on 7 May 1997 under the provisions of the Budapest Treaty on the International Recognition of the Deposit of Microorganisms for the Purpose of Patent Procedure under Accession Number B-21661. NRRL is the abbreviation for the Agricultural Research Service Culture Collection, an international depositary authority for the purposes of depositing microorganism strains under the Budapest Treaty, having the address National Center for Agricultural Utilization Research, Agricultural Research Service, U.S. Department of Agriculture, 1815 North University Street, Peoria, Ill. 61604, U.S.A. Suitable formulations of the Bacillus subtilis strain QST713 are commercially available under the tradenames SERENADE®, SERENADE® ASO, SERENADE SOIL® and SERENADE® MAX from Bayer CropScience LP, North Carolina, U.S.A. The SERENADE® product (U.S. EPA Registration No. 69592-12) is a fermentation product of Bacillus subtilis strain QST713, which contains spores of the strains as well as its metabolites.

Microbes that promote plant health also include Bacillus pumilus strains, such as Bacillus pumilus QST2808. In some embodiments the Bacillus pumilus strain is B. pumilus QST2808, which is described in U.S. Pat. Nos. 6,245,551 and 6,586,231, and in International Patent Publication No. WO 2000/058442. Suitable formulations of the Bacillus pumilus strain 2808 are available under the tradename SONATA® from Bayer CropScience LP, North Carolina, U.S.A. Bacillus pumilus strain QST2808 (also known as AQ2808) has been deposited with the NRRL on 14 Jan. 1999 under the provisions of the Budapest Treaty on the International Recognition of the Deposit of Microorganisms for the Purpose of Patent Procedure under Accession Number B-30087.

Microbes that improve plant health also include Bacillus amyloliquefaciens FZB42 (available as RhizoVital® from ABiTEP, DE). FZB42 is also described in European Patent Publication No. EP2179652 and also in Chen, et al., “Comparative Analysis of the Complete Genome Sequence of the Plant Growth-Promoting Bacterium Bacillus amyloliquefaciens FZB42,” Nature Biotechnology Volume 25, Number 9 (September 2007).

Microbes that promote plant health also include mutants of the above-referenced strains. The term “mutant” refers to a genetic variant derived from QST713, QST2808 or FZB42. In one embodiment, the mutant has one or more or all of the identifying (functional) characteristics of a parent strain. In another embodiment, the mutant or a fermentation product thereof increases health and/or growth of a plant or plant part (as an identifying functional characteristic) at least as well as the parent strain. Such mutants may be genetic variants having a genomic sequence that has greater than about 85%, greater than about 90%, greater than about 95%, greater than about 98%, or greater than about 99% sequence identity to the parent strain. Mutants may be obtained by treating parent strain cells with chemicals or irradiation or by selecting spontaneous mutants from a population of parent strain cells (such as phage resistant or antibiotic resistant mutants) or by other means well known to those practiced in the art.

Mutants of Bacillus subtilis QST713 having enhanced plant health and/or growth promoting capabilities are described in International Patent Publication No. WO 2012/087980. Such mutants have a mutation in the swrA⁻ gene. Exemplary swrA⁻ mutants have been deposited with the NRRL under the provisions of the Budapest Treaty on the International Recognition of the Deposit of Microorganisms for the Purpose of Patent Procedure. Specifically, Bacillus subtilis QST30002 was deposited on Oct. 5, 2010, and was assigned Accession Number B-50421. In addition, Bacillus subtilis QST30004 was deposited on Dec. 6, 2010 and was assigned Accession Number B-50455.

Mutants of FZB42 are described in International Application Publication No. WO 2012/130221, including Bacillus amyloliquefaciens ABI01, which was assigned Accession No. DSM 10-1092 by the DSMZ—German Collection of Microorganisms and Cell Cultures.

In one embodiment in which a synergistic combination of a polyene fungicide and plant health enhancing microbe is applied to a soybeen seed, a soybean root, or to soil in which soybean is growing or in which it is about to be planted either sequentially or at the same time (such as through a tank mix or pre-mix of the two components), the polyene fungicide is natamycin and the plant growth enhancing microbe is Bacillus subtilis QST713 or mutants thereof, Bacillus pumilus QST2808 or mutants thereof, or Bacillus amyloliquefaciens FZB42 or mutants thereof. In another embodiment in which a synergistic combination of a polyene fungicide and plant health enhancing microbe is applied to a soybeen seed, a soybean root, or to soil in which soybean is growing or in which it is about to be planted either sequentially or at the same time (such as through a tank mix or pre-mix of the two components), the polyene fungicide is nystatin and the plant growth enhancing microbe is Bacillus subtilis QST713 or mutants thereof, Bacillus pumilus QST2808 or mutants thereof, or Bacillus amyloliquefaciens FZB42 or mutants thereof. In another embodiment in which a synergistic combination of a polyene fungicide and plant health enhancing microbe is applied a soybeen seed, a soybean root, or to soil in which soybean is growing or in which it is about to be planted either sequentially or at the same time (such as through a tank mix or pre-mix of the two components), the polyene fungicide is amphotericin B and the plant growth enhancing microbe is Bacillus subtilis QST713 or mutants thereof, Bacillus pumilus QST2808 or mutants thereof, or Bacillus amyloliquefaciens FZB42 or mutants thereof. In another embodiment in which a synergistic combination of a polyene fungicide and plant health enhancing microbe is applied a soybeen seed, a soybean root, or to soil in which soybean is growing or in which it is about to be planted either sequentially or at the same time (such as through a tank mix or pre-mix of the two components), the polyene fungicide is aureofungin and the plant growth enhancing microbe is Bacillus subtilis QST713 or mutants thereof, Bacillus pumilus QST2808 or mutants thereof, or Bacillus amyloliquefaciens FZB42 or mutants thereof. In another embodiment in which a synergistic combination of a polyene fungicide and plant health enhancing microbe is applied to a soybeen seed, a soybean root, or to soil in which soybean is growing or in which it is about to be planted either sequentially or at the same time (such as through a tank mix or pre-mix of the two components), the polyene fungicide is filipin and the plant growth enhancing microbe is Bacillus subtilis QST713 or mutants thereof, Bacillus pumilus QST2808 or mutants thereof, or Bacillus amyloliquefaciens FZB42 or mutants thereof. In another embodiment in which a synergistic combination of a polyene fungicide and plant health enhancing microbe is applied to a soybeen seed, a soybean root, or to soil in which soybean is growing or in which it is about to be planted either sequentially or at the same time (such as through a tank mix or pre-mix of the two components), the polyene fungicide is lucensomycin and the plant growth enhancing microbe is Bacillus subtilis QST713 or mutants thereof, Bacillus pumilus QST2808 or mutants thereof, or Bacillus amyloliquefaciens FZB42 or mutants thereof.

In a preferred embodiment the above-described plant health enhancing microbes are provided as fermentation products, either formulated with inerts and/or carriers or unformulated, having a concentration of at least 10⁵ colony forming units per gram preparation (e.g., cells/g preparation, spores/g preparation), such as 10⁵-10¹² cfu/g, 10⁶-10¹¹ cfu/g, 10⁷-10¹⁰ cfu/g and 10⁹-10¹⁰ cfu/g.

The polyene fungicides and plant health enhancing microbes are used in a synergistic weight ratio. The skilled person is able to find out the synergistic weight ratios for the present invention by routine methods. The skilled person understands that these ratios refer to the ratio within a combined-formulation as well as to the calculative ratio of the polyene fungicide and plant health enhancing microbe when both components are applied as mono-formulations to a plant, seed or locus of growth (e.g., soil or potting mix) to be treated. The skilled person can calculate this ratio by simple mathematics since the volume and the amount of the two components to be used when applied alone is known. Application rates for polyene fungicides, applied alone, are provided herein. Labels for the commercial products based on the particular microbial strains described above (Bacillus subtilis QST713, Bacillus pumilus QST2808, and Bacillus amyloliquefaciens FZB42) are available and provide exemplary application rates for a formulated fermentation product of each strain, when applied alone. Generally, when used as a seed treatment, the plant health enhancing microbial compositions of the present invention (such as those based on Bacillus subtilis QST713, Bacillus pumilus QST2808, and Bacillus amyloliquefaciens FZB42) are applied at a rate of about 1×10² to about 1×10¹⁰ colony forming units (“cfu”)/seed, depending on the size of the seed. The plant health enhancing microbial compositions of the present invention (such as those based on Bacillus subtilis QST713, Bacillus pumilus QST2808, and Bacillus amyloliquefaciens FZB42) may also be used as a soil surface drench, shanked-in, injected and/or applied in-furrow or by mixture with irrigation water. The rate of application for drench soil treatments, which may be applied at planting, during or after seeding, or after transplanting and at any stage of plant growth, is about 4×10⁷ to about 8×10¹⁴ cfu per acre or about 4×10⁹ to about 8×10¹³ cfu per acre or about 4×10¹¹ to about 8×10¹² cfu per acre or about 2×10¹² to about 6×10¹³ cfu per acre or about 2×10¹² to about 3×10¹³ cfu per acre.

Bacterial inoculants are compositions comprising beneficial bacteria that are used to inoculate soil, often at the time of planting. Such bacterial inoculants include nitrogen-fixing bacteria or rhizobia bacteria. Bradyrhizobia japonicum is commonly used for soybean inoculation and Bradyrhizobia sp. (Vigna) or (Arachis) for peanuts. Other rhizobia are used with other crops: Rhizobium leguminosarum for peas, lentils and beans and alfalfa and clover and Rhizobium loci, Rhizobium leguminosarum and Bradyryizobium spp. for various legumes. In one embodiment, the compositions of the present invention are mixed with or further comprise at least one bacterial inoculant and then applied to soil or to seed. In another embodiment, the compositions and bacterial inoculant are applied to a plant, a plant part or the locus of the plant or plant part at the same time or sequentially.

In any of the embodiments described herein, the methods and compositions of the invention exclude the use, or inclusion, of pyridinyl ethylbenzamide derivatives. See WO 2012/071520, hereby incorporated by reference in its entirety. In particular embodiments, the methods and compositions of the invention exclude the use, or inclusion, of compounds having the general composition (I):

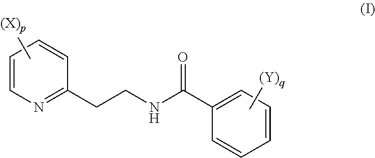

wherein:
p is an integer equal to 1, 2, 3, or 4;
q is an integer equal to 1, 2, 3, 4, or 5;
each X is independently selected from the group consisting of halogen, alkyl, and haloalkyl, provided that at least one X is a haloalkyl;
each Y is independently selected from the group consisting of halogen, alkyl, alkenyl, alkynyl, haloalkyl, alkoxy, amino, phenoxy, alkylthio, dialkylamino, acyl, cyano, ester, hydroxyl, aminoalkyl, benzyl, haloalkoxy, halosulfonyl, halothioalkyl, alkoxyalkenyl, aminoalkyl, benzyl, haloalkoxy, halosulfonyl, phenylsulfonyl, and benzylsulfonyl.

The following examples are illustrative and non-limiting.

### EXAMPLES

### Example 1

### Different Concentrations of Natamycin were Assessed for Zones of Inhibition Against F. virguliforme in an Agar Diffusion Assay

A PDA plate containing two week old F. virguliforme was flooded with sterile distilled water and scraped with an L-rod to release spores. The spore solution was poured through about four layers of cheese cloth into a 50 mL conical tube. Spores were quantified using a hemacytometer, then diluted to 1×10⁵ spores/mL. (1×10⁴ spores were spread on plates.) To make F. virguliforme lawn plates, 100 μL of the spore suspension was spread onto commercial PDA plates. Wells were made for the F. virguliforme lawn plates using straw-plungers.

Natamycin stock was diluted in sterile distilled water to concentrations of 500 ppm, 250 ppm, 100 ppm, 50 ppm, 25 ppm, 12.5 ppm, 6.25 ppm, 3.13 ppm, 1.56 ppm, 0.78 ppm, and 0.4 ppm. 100 μL of each dilution was placed in a well on the lawn plates. Control plates consisted of a 1000 ppm plate, a water control, and a 70% ethanol (EtOH) control.

After 4-5 days, plates were evaluated for zones of inhibition. After three days, the 1000 ppm plate had almost completely controlled F. virguliforme. Substantial control was seen at 500 ppm, 250 ppm, 100 ppm. The control started to drop off slightly at 50 ppm, and noticeably at 12.5 ppm. This was more apparent one day later when more Fusarium grew around the 25 ppm and 12.5 ppm plates. Dilutions lower than 12.5 ppm had no effect. After seven days, natamycin control of F. virguliforme started falling off at 50 ppm. And at 12.5 ppm, there was very limited activity. The water and EtOH control plates similarly showed no effect on F. virguliforme.

### Example 2

### An in Planta Assay was Used to Assess Natamycin for Control of Sudden Death Syndrome of Soybean

Sorghum was prepared for inoculation. One to two liters of sorghum seed was put into spawn bags, autoclaved, then inoculated with 30-45 mL of an SDA spore suspension. Bags were left in a cupboard at room temperature, then shaken and mixed every few days for three weeks until ready. Sorghum inoculum was assessed for the number of spores per gram of seed by hemacytometer. The sorghum grew to 4.57×10⁵ spores/g.

F. virguliforme spores were enumerated before soil inoculation. First, 25 mL of sterile 0.1% Tween 80 in water was added to sterile 50 mL conical tubes. The tubes where weighed. Then several grains of colonized sorghum from the spawn bag were aseptically added. The tubes were re-weighed to find the exact mass of colonized spores added to the tube. The tubes were shaken at 28-30° C. at approximately 250 rpm for 2-4 hours to release spores from the sorghum seed. Samples were then removed from the tubes and spores were quantified using a hemacytometer. F. virguliforme spores were quantified by making a dilution series from each tube onto PDA plates with 100 ppm chloramphenicol antibiotic.

Soil inoculation began by grounding sorghum grain inoculum in a Waring blender in small batches for 10-20 seconds on the low setting. The ground sorghum was then mixed into Monterey sand fine #60 (Lapis Luster, RMC pacific materials) at either a “2% low rate,” consisting of 2×10⁵ spores/cone with 8.9 g/L of sand, or a “5% high rate,” consisting of 5×10⁵ spores/cone with 22.5 g/L of sand. The Monterey sand was not pre-sterilized. The ground sorghum inoculum was added on the same day as the experimental set up. In later experiments, ground sorghum inoculum was mixed into sand based on the enumerated spores per gram of inoculum.

Natamycin solution was added in four different concentrations to four different groups of untreated seeds in “2% low rate” infested soil cones. The four different concentrations were 250 ppm, 100 ppm, 50 ppm, and 25 ppm. Fifty milliliters of the natamycin solutions were used per cone.

The assays were planted by first moistening infested sand with water at 150 mL per liter of sand and mixing. The cone-shaped containers were filled 1-2 inches at the bottom with a Sunshine #3 potting mix plug in order to keep the sand in the tube. The containers were then filled to within 1-1.5 inches of the top with moistened and infested sand, taking an average of 120-125 mL to fill each container. The containers were then watered. Two soy seeds were planted into each container. The containers were then placed under light racks to germinate. One week post planting, most seeds had germinated. At this point, germinated seedlings were thinned, leaving only one seedling in each container.

The plants were allowed to grow for 18-21 days. The plants were then gently removed and assessed for root rot symptoms, with a rating of 1=0% infection on taproot and lateral roots, a 2=<25% infection, a 3=25-50% infection, a 4=51-90% infection, and a 5=>90% infection. Root vigor was rated such that a rating of 4=healthy taproot and many lateral roots, a 3=fewer lateral roots and some stunting, a 2=fewer or stringy lateral roots and more stunting, 1=thin tap root and only a few lateral roots, and a 0=thin and stunted taproot with 0-3 lateral roots.

The higher concentrations of natamycin, 250 ppm and 100 ppm natamycin per cone, were phytotoxic to the plants and the plants exhibited low germination and/or severe stunting. Lower natamycin concentrations (50 ppm and 25 ppm/container) were effective, significantly lowering root rot ratings and improving root vigor as compared to the infected control.

### Example 3

### Testing Lower Concentrations of Natamycin as a Drench Treatment on Seedlings for Control of SDS in Planta

Using a protocol similar to that described in Example, 2 lower concentrations of natamycin, 50 ppm, 25 ppm, 10 ppm, 5 ppm, and 1 ppm, were assessed for the treatment of SDS. Two experiments were performed.

The natamycin solutions were used as a drench treatment with 50 mL of the solution applied to each container. Soy seedlings were transplanted into SDS infested soil, with SDS spores at a rate of 1×10⁷ spores/container. The natamycin solutions were applied to the containers the day after transplant. Soy roots were washed after eighteen days.

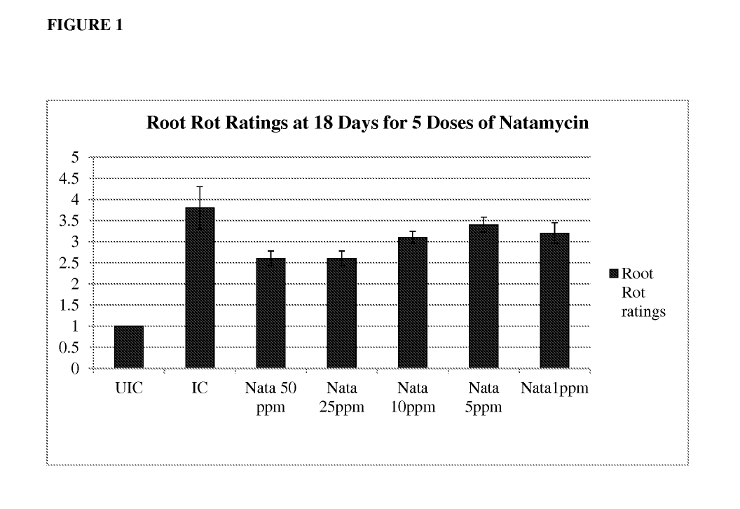

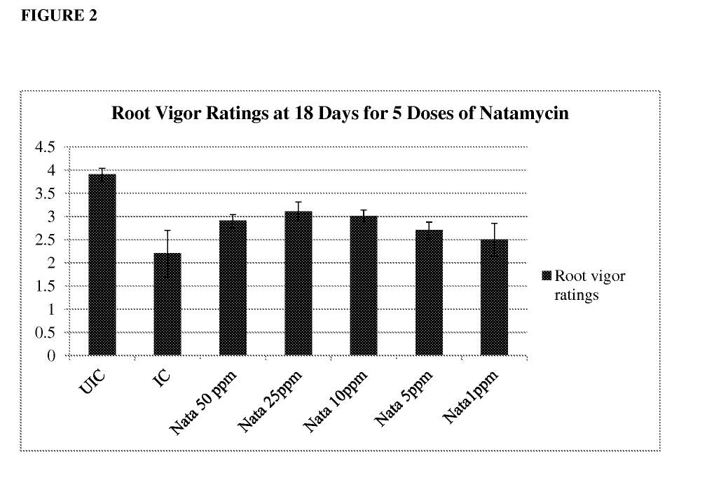

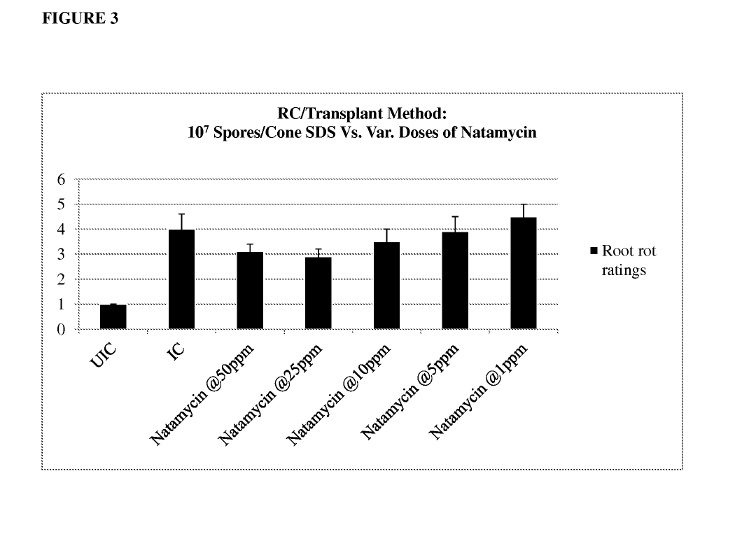

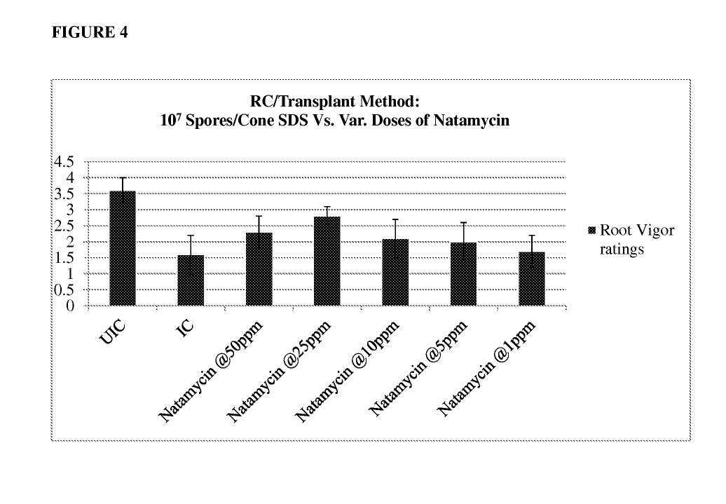

FIGS. 1 and 2 show the results of the first experiment, and FIGS. 3 and 4 show the results of the second experiment. In particular, the data shows that the root rot ratings for natamycin treated plants at 50 ppm, 25 ppm, and 10 ppm per container were significantly lower (i.e., better) than the infested control (IC) plants and root vigor ratings were higher (i.e., better) than the IC plants. Therefore, the data shows that natamycin at 50 ppm, 25 ppm, and 10 ppm can be used to control SDS root rot with a drench application.

### Example 4

### Testing Natamycin at Low Concentrations as a Drench Treatment on Seedlings for Control of SDS in Planta

Using a protocol similar to that described in Example 2, natamycin at concentrations of 50 ppm, 25 ppm, 10 ppm, 5 ppm, and 1 ppm was assessed for the treatment of SDS in two identical experiments.

In these experiments, the inoculum rate was measured by spores/cone at approximately 1×10⁷ SDS Fusarium virguliforme spores per cone.

Soy plants were germinated first and then transplanted into infested soil. The soybean seeds were germinated in clean sand/soil for 12 days and then seedlings were transplanted into infested soil for 18 days. Natamycin drench was applied 24 hours after transplanting. Natamycin treatment was assessed at 2.5 weeks.

Table 1 shows that, in both experiments, roots treated with natamycin at 50 ppm and 25 ppm had the lowest root rot ratings, while those treated with 10 ppm and 5 ppm had higher ratings, albeit still lower than the infected and untreated control. The roots treated with natamycin at 1 ppm showed lower root rot in one experiment when compared to the infected and untreated control. In the tables below, UIC refers to uninfested control and IC refers to infested control.

TABLE 1

| | | Root Rot | | Root Rot |
|---|---|---|---|---|
| | Root Rot | Standard | Root Rot | Standard |
| Sample | Average | Deviation | Average | Deviation |
| Name | Expt. 1 | Expt. 1 | Expt. 2 | Expt. 2 |
| UIC | 1 | 0 | 1 | 0 |
| IC | 4 | 0.6 | 3.8 | 1 |
| Natamycin | 3.1 | 0.3 | 2.6 | 0.5 |
| 50 ppm | | | | |
| Natamycin | 2.9 | 0.3 | 2.6 | 0.5 |
| 25 ppm | | | | |
| Natamycin | 3.5 | 0.5 | 3.1 | 0.4 |
| 10 ppm | | | | |
| Natamycin | 3.9 | 0.6 | 3.4 | 0.5 |
| 5 ppm | | | | |
| Natamycin | 4.5 | 0.5 | 3.2 | 0.7 |
| 1 ppm | | | | |

Table 2 shows that in both experiments, roots treated with natamycin at 50 ppm and 25 ppm had the highest root vigor ratings, while those treated with 10 ppm, 5 ppm, and 1 ppm had lower ratings, albeit still higher than the infected and untreated control.

TABLE 2

| | | Root Vigor | | Root Vigor |
|---|---|---|---|---|
| | Root Vigor | Standard | Root Vigor | Standard |
| Sample | Average | Deviation | Average | Deviation |
| Name | Expt. 1 | Expt. 1 | Expt. 2 | Expt. 2 |
| UIC | 3.6 | 0.4 | 3.9 | 0.4 |
| IC | 1.6 | 0.6 | 2.2 | 1 |
| Natamycin | 2.3 | 0.5 | 2.9 | 0.4 |
| 50 ppm | | | | |
| Natamycin | 2.8 | 0.3 | 3.1 | 0.6 |
| 25 ppm | | | | |
| Natamycin | 2.1 | 0.6 | 3 | 0.4 |
| 10 ppm | | | | |
| Natamycin | 2 | 0.6 | 2.7 | 0.5 |
| 5 ppm | | | | |
| Natamycin | 1.7 | 0.5 | 2.5 | 1 |
| 1 ppm | | | | |

Therefore, the data shows that natamycin at 5 ppm, 10 ppm, 25 ppm, and 50 ppm can be used to control SDS root rot with a drench application, with 25 ppm and 50 ppm presenting the best results.

### Example 5

### Testing of Natamycin as a Seed Treatment at Low Concentrations for Control of SDS in Planta

Using a protocol similar to Example 2, natamycin treated seeds were tested at 50 μg, 25 μg, 10 μg, 5 μg, and 1 μg natamycin per seed. Briefly, seeds were coated with a natamycin slurry and then allowed to air dry. Ten samples of each were planted into infested soil, while five samples of each were planted in uninfested soil to compare germination and potential phytotoxicity.

Inoculum rates in this experiment were 25 g inoculum per liter sand/soil. This is equivalent to 8.5×10⁴ spores per cone.

Table 3 shows that, in infested soil, all plants with natamycin seed treatments resulted in root rot symptoms that were the same or worse than the untreated control. Plants treated with 50 μg/seed of natamycin had the most root rot, while plants treated with 1 μg/seed of natamycin had the least root rot. These results suggest a negative dose response with a lower natamycin concentration being better than a higher one. In the tables below, “IC Natamycin 25 ppm” refers to an infested control that was treated with natamcyin as a drench application at 25 ppm two days after planting untreated seed into infested soil.

TABLE 3

| | Rate (μg/ | Root Rot | Root Rot |
|---|---|---|---|
| Sample Name | seed) | Average | Standard Deviation |
| UIC | | 1 | 0 |
| IC | | 3.3 | 0.8 |
| IC Natamycin 25 ppm | | 1.8 | 0.4 |
| Natamycin | 50 μg | 4.6 | 0.5 |
| Natamycin | 25 μg | 4.7 | 0.5 |
| Natamycin | 10 μg | 4 | 0.9 |
| Natamycin | 5 μg | 3.6 | 1 |
| Natamycin | 1 μg | 3 | 0.8 |

All plants in un-infested (i.e., clean) soil germinated at all natamycin concentrations, demonstrating that natamycin treatment at all concentrations was not phytotoxic to seeds. Natamycin treatment at 5 μg/seed in uninfested soil had the most vigorous roots from all of the natamycin treatments in clean or infested soil. The roots treated with 25 μg/seed of natamycin had the lowest root vigor in infested soil, once again suggesting that a lower concentration of natamycin is better than a higher one. See data in Table 4.

TABLE 4

| | | | Root | | |
|---|---|---|---|---|---|
| | | Root | Vigor | | Root Vigor |
| | | Vigor | Standard | Root Vigor | Standard |
| | Rate | Average | Deviation | Average | Deviation |
| | μg/ | Infested | (Infested | (Uninfested | (Uninfested |
| Sample Name | seed | Soil | Soil) | Soil) | Soil) |
| UIC | | | 0.4 | 3.5 | |
| IC | | 2.5 | 0.7 | | |
| IC Natamycin | | 2.3 | 0.6 | | |
| 25 ppm | | | | | |
| Natamycin | 50 | 1.6 | 0.9 | 3.8 | 0.3 |
| Natamycin | 25 | 1.1 | 0.9 | 3.3 | 0.4 |
| Natamycin | 10 | 1.8 | 1 | 3.6 | 0.4 |
| Natamycin | 5 | 2.4 | 0.9 | 3.9 | 0.2 |
| Natamycin | 1 | 1.9 | 0.9 | 3.5 | 0.4 |

### Example 6

### Comparison of Inoculum Rates on Treated Seeds for Control of SDS in Planta

Using a protocol similar to that described in Example 5, natamycin at concentrations of 50 μg, 25 μg, 10 μg, 5 μg, and 1 μg was assessed for the treatment of SDS.

Because these were chemical seed treatments, seeds were planted directly into infested soil. Inoculum rates of 25 g/L inoculum and 8 g/L inoculum were compared, corresponding to approximately 10⁵ SDS spores per container and 10⁴-10⁵ SDS spores per container, respectively. Assessment occurred after 18 and 22 days.

Table 5 shows that the root rot averages for 25 g/L inoculum are higher than that of 8 g/L inoculum. Table 5 also shows that the root vigor averages for 25 g/L were similar to that of 8 g/L.

For the seed treatment experiments, the results were not as consistent as the drench experiments. In both seed treatment experiments, and at both SDS inoculum rates, no consistent decrease of root rot symptoms was observed.

TABLE 5

| | | | | | | Root |
|---|---|---|---|---|---|---|
| | | Inoc | Root | Root Rot | Root | Vigor |
| Sample | μg/ | Rate of | Rot | Standard | Vigor | Standard |
| Name | seed | spores | Average | Deviation | Average | Deviation |
| UIC | | 0 | 1 | 0 | 3.6 | 0.7 |
| IC | | 8 | 2.9 | 0.8 | 2.3 | 0.8 |
| IC Nata 25 | | 8 | 2.6 | 1.1 | 1.9 | 0.4 |
| ppm | | | | | | |
| Natamycin | 50 | 8 | 2.8 | 0.8 | 1.9 | 0.6 |
| Natamycin | 25 | 8 | 2.3 | 0.5 | 1.8 | 0.7 |
| Natamycin | 10 | 8 | 2.4 | 0.7 | 2.2 | 0.8 |
| Natamycin | 5 | 8 | 2.4 | 0.7 | 1.4 | 0.7 |
| Natamycin | 1 | 8 | 2.9 | 0.7 | 1.9 | 0.6 |
| IC | | 25 | 3.9 | 0.8 | 1.6 | 0.4 |
| IC Nata 25 | | 25 | 4.1 | 0.9 | 2.3 | 0.5 |
| ppm | | | | | | |
| Natamycin | 50 | 25 | 3.8 | 0.7 | 2.1 | 0.9 |
| Natamycin | 25 | 25 | 3.6 | 0.5 | 2.2 | 0.6 |
| Natamycin | 10 | 25 | 4.1 | 0.7 | 1.9 | 0.5 |
| Natamycin | 5 | 25 | 4.1 | 0.9 | 2.6 | 0.9 |
| Natamycin | 1 | 25 | 4.1 | 0.6 | 2.1 | 1.2 |

All publications, patents and patent applications, including any drawings and appendices therein, are incorporated by reference to the same extent as if each individual publication, patent or patent application was specifically and individually indicated to be incorporated by reference.

1. A method for treating and/or preventing sudden death syndrome comprising applying an effective amount of a polyene fungicide to a plant seed, to soil in which a plant is growing, to soil in which a plant or seed is about to be planted, to plant roots, or to combinations thereof.

2. The method of claim 1, wherein the applying is to a soybean seed, a soybean root, or to soil in which soybean is growing or in which it is about to be planted, or to a combination thereof.

3. The method of claim 2, wherein the polyene fungicide is natamycin, nystatin, amphotericin B, aureofungin, filipin, lucensomycin, or combinations thereof.

4. The method of claim 3, wherein the polyene fungicide is natamycin.

5. The method of claim 2, wherein the polyene fungicide is applied in a concentration of 25 ppm to 50 ppm.

6. The method of claim 2, wherein said polyene fungicide is included in a composition comprising said fungicide and an agriculturally acceptable carrier.

7. The method of claim 2, wherein said composition does not comprise a compound of general composition (I): 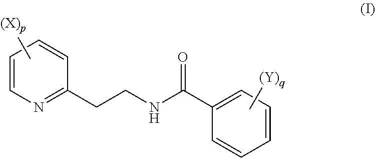
wherein:
p is an integer equal to 1, 2, 3, or 4;
q is an integer equal to 1, 2, 3, 4, or 5;
each X is independently selected from the group consisting of halogen, alkyl, and haloalkyl, provided that at least one X is a haloalkyl;
each Y is independently selected from the group consisting of halogen, alkyl, alkenyl, alkynyl, haloalkyl, alkoxy, amino, phenoxy, alkylthio, dialkylamino, acyl, cyano, ester, hydroxyl, aminoalkyl, benzyl, haloalkoxy, halosulfonyl, halothioalkyl, alkoxyalkenyl, aminoalkyl, benzyl, haloalkoxy, halosulfonyl, phenylsulfonyl, and benzylsulfonyl.

8. A method for controlling Fusarium virguliforme or Fusarium tucumaniae fungi comprising applying an effective amount of a polyene fungicide to a plant seed, to soil in which a plant or seed is about to be planted, to plant roots, or to combinations thereof.

9. The method of claim 8, wherein the polyene fungicide is natamycin, nystatin, amphotericin B, aureofungin, filipin, lucensomycin, or combinations thereof.

10. The method of claim 9 wherein the polyene fungicide is natamycin.

11. The method of claim 8, wherein the applying is to a soybean seed, a soybean root, or to soil in which soybean is growing or in which it is about to be planted, or to a combination thereof.

12. The method of claim 8, wherein the polyene fungicide is applied in a concentration of 25 ppm to 50 ppm.

13. The method of claim 8, wherein said polyene fungicide is included in a composition comprising said fungicide and an agriculturally acceptable carrier.

14. The method of claim 8, wherein the polyene fungicide does not comprise a compound of general composition (I): 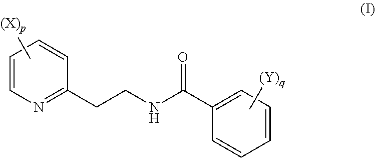
wherein:
p is an integer equal to 1, 2, 3, or 4;
q is an integer equal to 1, 2, 3, 4, or 5;
each X is independently selected from the group consisting of halogen, alkyl, and haloalkyl, provided that at least one X is a haloalkyl;
each Y is independently selected from the group consisting of halogen, alkyl, alkenyl, alkynyl, haloalkyl, alkoxy, amino, phenoxy, alkylthio, dialkylamino, acyl, cyano, ester, hydroxyl, aminoalkyl, benzyl, haloalkoxy, halosulfonyl, halothioalkyl, alkoxyalkenyl, aminoalkyl, benzyl, haloalkoxy, halosulfonyl, phenylsulfonyl, and benzylsulfonyl.

15. A treated soybean seed comprising a soybean seed coated with a polyene fungicide.

16. The soybean seed of claim 15, wherein the polyene fungicide is natamycin, nystatin, amphotericin B, aureofungin, filipin, lucensomycin, or combinations thereof.

17. The soybean seed of claim 16, wherein the soybean seed is coated with natamycin.

18. The treated soybean seed of any one of claims 15-17, wherein said soybean seed does not comprise a compound of general composition (I): 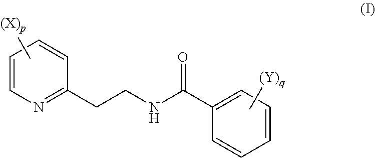
wherein:
p is an integer equal to 1, 2, 3, or 4;
q is an integer equal to 1, 2, 3, 4, or 5;
each X is independently selected from the group consisting of halogen, alkyl, and haloalkyl, provided that at least one X is a haloalkyl;
each Y is independently selected from the group consisting of halogen, alkyl, alkenyl, alkynyl, haloalkyl, alkoxy, amino, phenoxy, alkylthio, dialkylamino, acyl, cyano, ester, hydroxyl, aminoalkyl, benzyl, haloalkoxy, halosulfonyl, halothioalkyl, alkoxyalkenyl, aminoalkyl, benzyl, haloalkoxy, halosulfonyl, phenylsulfonyl, and benzylsulfonyl.
